(19) United States
(12) Patent Application Publication
(10) Pub. No.: US 2018/0044851 A1
(43) Pub. Date: Feb. 15, 2018

(54) SIZING AGENT FOR SYNTHETIC FIBER, REINFORCING FIBER BUNDLE, AND FIBER-REINFORCED COMPOSITE MATERIAL

(71) Applicant: NICCA CHEMICAL CO., LTD., Fukui-shi, Fukui (JP)

(72) Inventors: Kana UEDA, Fukui-shi, Fukui (JP); Hirotomo BANKO, Fukui-shi, Fukui (JP)

(21) Appl. No.: 15/553,200

(22) PCT Filed: Feb. 16, 2016
(86) PCT No.: PCT/JP2016/054372

§ 371 Date: Aug. 24, 2017

(30) Foreign Application Priority Data
Feb. 27, 2015 (JP) 2015-038560

(51) Int. Cl. D06M 15/65; C08K 9/06; C08J 5/10; D06M 15/55; C08J 5/04

(52) U.S. Cl. CPC D06M 15/65; D06M 15/55; C08J 5/042; C08J 5/10; C08K 9/06; D06M 2101/40

(57) ABSTRACT

The sizing agent for synthetic fiber contains an organo-modified silicone represented by the following General Formula (1) and an epoxy compound (B) having an aromatic ring.

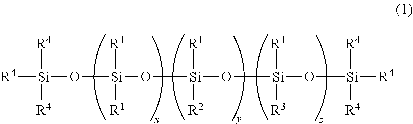

In Formula (1), R¹ represents a hydrogen atom, a methyl group, or an ethyl group, R² represents a group having an epoxy group R³ represents a hydrocarbon group having an aromatic ring and from 8 to 40 carbon atoms or an alkyl group having from 3 to 22 carbon atoms, R⁴ represents the same group as R¹, R², or R³, and a plurality of les, R²s, R³s, or R⁴s may be the same as or different from one another when there are a plurality of les, R²s, R³s, or R⁴s, x represents an integer of 0 or greater, y and z each represent an integer of 1 or greater, and (x+y+z) is from 10 to 200.

### TECHNICAL FIELD

The present invention relates to a sizing agent for synthetic fiber to be used in a fiber-reinforced composite material, a reinforcing fiber bundle obtained by using the sizing agent for synthetic fiber, and a fiber-reinforced composite material using the reinforcing fiber bundle.

### BACKGROUND ART

A fiber-reinforced composite material that is a resin molded. product obtained by combining various synthetic fiber bundles with a resin (referred to as a matrix resin) is utilized in a number of fields such as automobile members, aircraft and spacecraft members, civil engineering building materials, and sporting goods. Examples of the synthetic fiber to be used in such a synthetic fiber bundle may include various kinds of inorganic fibers such as carbon fibers, glass fibers, and ceramic fibers and various kinds of organic fibers such as aramid fibers, polyamide fibers, and polyethylene fibers. Among them, carbon fibers are often used since they have a light weight, strength, and excellent mechanical strengths such as an elastic modulus. Such carbon fibers are manufactured by subjecting a carbon fiber precursor (precursor) to which an oil solution such as silicone is attached to a heating carbonization treatment.

The various kinds of synthetic fibers described above are usually used as a reinforcing fiber bundles that are subjected to a treatment with a sizing agent so as to exhibit bundling property which suppresses the occurrence of fluff, thread breakage, and the like during processing.

Hitherto, those using a compound having an epoxy group are used as a sizing agent. As a treatment method using a sizing agent, for example, a method in which a carbon fiber is coated with diglycidyl ether of bisphenol A (Patent Literatures 1 and 2), a method in which a carbon fiber is coated with one obtained by adding an epoxy group to a polyalkylene oxide adduct of bisphenol A (Patent Literatures 3 and 4), and a method in which a carbon fiber is coated with a sizing agent which concurrently uses an aliphatic epoxy compound and an aromatic epoxy compound (Patent Literatures 5 and 6) have been proposed. In addition, it has also been investigated to use a phenol novolak type epoxy resin.

### CITATION LIST

### Patent Literature

Patent Literature 1: Japanese Unexamined Patent Publication No. S50-059589

Patent Literature 2: Japanese Unexamined Patent Publication No. S57-171767

Patent Literature 3: Japanese Unexamined Patent Publication No. S61-028074

Patent Literature 4: Japanese Unexamined Patent Publication No. H01-272867

Patent Literature 5: Japanese Unexamined Patent Publication No. 2014-159564

Patent Literature 6: Japanese Unexamined Patent Publication No. 2014-159664

### SUMMARY OF INVENTION

### Technical Problem

Incidentally, in a fiber-reinforced composite material, it is important that the adhesive property between the reinforcing fiber bundle and the matrix resin is favorable in order that the reinforcing fiber bundle more effectively reinforces the matrix resin. However, there is a problem that satisfactory adhesive property cannot be obtained by the methods described above since the applications and method of use of fiber-reinforced composite materials have been diversified and further improvement in strength has been desired in recent years.

Furthermore, there is a problem in the methods described above that the flexibility of the carbon fiber bundle is impaired and handling property deteriorates so that it is difficult to wind the carbon fiber bundle onto a roll.

The present invention has been made in view of the above circumstances, and an object thereof is to provide a sizing agent for synthetic fiber which can impart excellent adhesive property with a matrix resin to a synthetic fiber bundle to be used in order to reinforce the matrix resin of a fiber-reinforced composite material and sufficiently suppress a deterioration in flexibility of the synthetic fiber bundle in a reinforcing fiber bundle to be obtained, a reinforcing fiber bundle obtained by using the sizing agent for synthetic fiber, and a fiber-reinforced composite material using the reinforcing fiber bundle.

### Solution to Problem

The present inventors have carried out intensive researches to solve the above problem, and as a result, it has been found out that the above problem can be solved by concurrently using an organo-modified silicone having an epoxy group and an alkyl group or an aralkyl group in the molecule and an epoxy compound having an aromatic ring, thereby completing the present invention.

In other words, the present invention provides a sizing agent for synthetic fiber containing an organo-modified silicone (A) represented by the following General Formula (1) and an epoxy compound (B) having an aromatic ring.

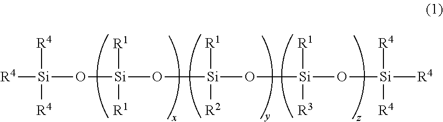

In Formula (1), R¹ represents a hydrogen atom, a methyl group, or an ethyl group, R² represents a group represented by the following Formula (2), R³ represents a hydrocarbon group having an aromatic ring and from 8 to 40 carbon atoms or an alkyl group having from 3 to 22 carbon atoms, R⁴ represents the same group as R¹, R², or R³, and a plurality of R¹s, R²s, R³s, or les may be the same as or different from one another when there are a plurality of R¹s, R²s, R³s, or R⁴s, x represents an integer of 0 or greater, y and z each represent an integer of 1 or greater, and (x+y+z) is from 10 to 200.

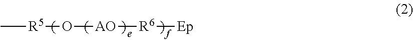

In Formula (2), R⁵ represents an alkylene group having from 2 to 6 carbon atoms, AO represents an alkyleneoxy group having from 2 to 4 carbon atoms, R⁶ represents an alkylene group having from 1 to 6 carbon atoms, e represents an integer from 0 to 4, f represents an integer of 0 or 1, and Ep represents a group represented by the following Formula (3) or the following Formula (4).

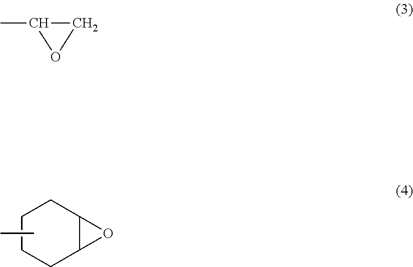

By using the sizing agent for synthetic fiber of the present invention, it is possible to obtain a reinforcing fiber bundle exhibiting excellent bundling property and adhesive property with a matrix resin while sufficiently maintaining the flexibility of the synthetic fiber bundle.

In the sizing agent for synthetic fiber of the present invention, it is preferable that the epoxy compound (B) is at least one kind of epoxy compound selected from the group consisting of a glycidyl ether type epoxy compound, a glycidyl amine type epoxy compound, and a glycidyl ester type epoxy compound.

In the sizing agent for synthetic fiber of the present invention, it is preferable that the epoxy compound (B) is at least one kind of epoxy compound selected from the group consisting of a compound obtained by reacting a polyol having an aromatic ring with epichlorohydrin, a compound obtained by reacting an amine having an aromatic ring and a plurality of active hydrogen with epichlorohydrin, a compound obtained by reacting a polycarboxylic acid having an aromatic ring with epichlorohydrin.

In the sizing agent for synthetic fiber of the present invention, it is preferable that the mass ratio (A):(B) of the organo-modified silicone (A) to the epoxy compound (B) is from 95:5 to 20:80.

In addition, the present invention provides a reinforcing fiber bundle in which the sizing agent for synthetic fiber according to the present invention described above is attached to a synthetic fiber bundle.

The reinforcing fiber bundle of the present invention exhibits excellent handling property as well as excellent adhesive property with the matrix resin, and it is thus possible to prevent a problem that it is difficult to wind the reinforcing fiber bundle onto a roll and to improve the working property.

In the reinforcing fiber bundle of the present invention, it is preferable that the synthetic fiber bundle is a carbon fiber bundle.

Furthermore, the present invention provides a fiber-reinforced. composite material containing a matrix resin and the reinforcing fiber bundle according to the present invention described above.

### Advantageous Effects of Invention

According to the present invention, it is possible to provide a sizing agent for synthetic fiber which can impart excellent adhesive property with a matrix resin to a synthetic fiber bundle to be used in order to reinforce the matrix resin of a fiber-reinforced composite material and sufficiently suppress a deterioration in flexibility of the synthetic fiber bundle in a reinforcing fiber bundle to be obtained, a reinforcing fiber bundle obtained by using the sizing agent for synthetic fiber, and a fiber-reinforced composite material using the reinforcing fiber bundle.

### DESCRIPTION OF EMBODIMENTS

The sizing agent for synthetic fiber of the present embodiment contains an organo-modified silicone (A) represented by the following General Formula (1) and an epoxy compound (B) having an aromatic ring.

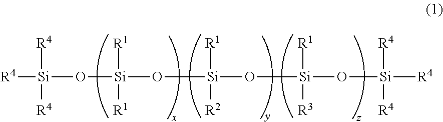

In Formula (1), R¹ represents a hydrogen atom, a methyl group, or an ethyl group, and a plurality of R¹s may be the same as or different from one another. Among these, a methyl group is preferable since it is industrially more easily available.

In Formula (1), R² represents a group represented by the following Formula (2), and a plurality of R²s may be the same as or different from one another in a case in which there are a plurality of R²s.

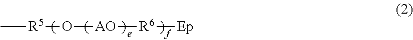

In Formula (2), R⁵ represents an alkylene group which may be straight-chain or branched-chain and has from 2 to 6 carbon atoms. R⁵ is preferably an alkylene group having from 2 to 4 carbon atoms from the viewpoint of exhibiting superior adhesive property and of being easier to manufacture the organo-modified silicone.

In Formula (2), AO represents an alkyleneoxy group which may be straight-chain or branched-chain and has from 2 to 4 carbon atoms, and a plurality of AOs may be the same as or different from one another in a case in which there are a plurality of AOs. AO is preferably an alkyleneoxy group having 2 or 3 carbon atoms from the viewpoint of exhibiting superior adhesive property and of being easier to manufacture the organo-modified silicone.

In Formula (2), R⁶ represents an alkylene group which may be straight-chain or branched-chain and has from 1 to 6 carbon atoms. R⁶ is preferably an alkylene group having from 1 to 4 carbon atoms from the viewpoint of exhibiting superior adhesive property and of being easier to manufacture the organo-modified silicone.

In Formula (2), e represents an integer from 0 to 4. e is preferably from 0 to 2 from the viewpoint of exhibiting superior adhesive property and of being easier to manufacture the organo-modified silicone.

In Formula (2), f represents an integer of 0 or 1. f is preferably 1 from the viewpoint of exhibiting superior adhesive property.

In Formula (2), Ep represents a group represented by the following Formula (3) or the following Formula (4).

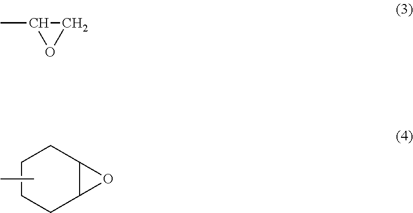

As Ep, the group represented by Formula (3) above is preferable since the adhesive property is superior.

In Formula (1), R³ represents a hydrocarbon group having an aromatic ring and from 8 to 40 carbon atoms or an alkyl group having from 3 to 22 carbon atoms. A plurality of R³s may be the same as or different from one another in a case in which there are a plurality of R³s. It is difficult to handle the organo-modified silicone as the viscosity thereof is too high when the number of carbon atoms exceeds 40 in a case in which R³ is a hydrocarbon group having an aromatic ring. In addition, it is difficult to handle the organo-modified silicone as the viscosity thereof is too high when the number of carbon atoms exceeds 22 in a case in which R³ is an alkyl group.

Examples of the hydrocarbon group having an aromatic ring and from 8 to 40 carbon atoms may include an aralkyl group having from 8 to 40 carbon atoms and a group represented by the following Formula (5) or the following Formula (6).

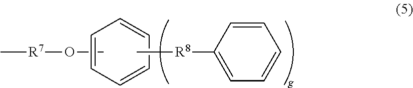

In Formula (5), R⁷ represents an alkylene group which may be straight-chain or branched-chain and has from 2 to 6 carbon atoms, R⁸ represents a single bond or an alkylene group having from 1 to 4 carbon atoms, and g represents an integer from 0 to 3. R⁷ is preferably an alkylene group having from 2 to 4 carbon atoms from the viewpoint of exhibiting superior adhesive property and of being easier to manufacture the organo-modified. In addition, g is preferably 0 or 1 from the viewpoint of being easier to manufacture the organo-modified silicone.

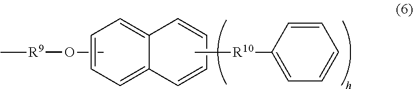

In Formula (6), R⁹ represents an alkylene group which may be straight-chain or branched-chain and has from 2 to 6 carbon atoms, R¹⁰ represents a single bond or an alkylene group having from 1 to 4 carbon atoms, and h represents an integer from 0 to 3. le is preferably an alkylene group having from 2 to 4 carbon atoms from the viewpoint of exhibiting superior adhesive property and of being easier to manufacture the organo-modified silicone. In addition, h is preferably 0 from the viewpoint of being easier to manufacture the organo-modified silicone.

Examples of the aralkyl group having from 8 to 40 carbon atoms may include a phenylethyl group, a phenylpropyl group, a phenylbutyl group, a phenylpentyl group, a phenylhexyl group, and a naphthylethyl group. Among these, a phenylethyl group and a phenylpropyl group are preferable since the adhesive property is superior.

Among the hydrocarbon groups having an aromatic ring and from 8 to 40 carbon atoms, the aralkyl groups described above and the group represented by Formula (5) are preferable from the viewpoint of being easier to manufacture the organo-modified silicone, and the aralkyl groups are more preferable from the viewpoint of exhibiting superior adhesive property.

The alkyl group having from 3 to 22 carbon atoms may be straight-chain or branched-chain, and an alkyl group having from 4 to 12 carbon atoms is more preferable since the adhesive property is superior. Examples of such an alkyl group may include a butyl group, a pentyl group, a hexyl group, a heptyl group, an octyl group, a nonyl group, a decyl group, an undecyl group, and a dodecyl group.

From the viewpoint of exhibiting superior adhesive property, the organo-modified silicone represented by General Formula (1) above preferably has a hydrocarbon group having an aromatic ring and from 8 to 40 carbon atoms as R³. Furthermore, the molar ratio of the hydrocarbon group having an aromatic ring and from 8 to 40 carbon atoms to the alkyl group having from 3 to 22 carbon atoms in the organo-modified silicone represented by General Formula (1) above is preferably from 100:0 to 40:60.

In Formula (1), R⁴ represents the same group as R¹, R², or R³ described above, and a plurality of R⁴s may be the same as or different from one another. From the viewpoint of being industrially easily available, R⁴ is preferably the same group as R¹, and a methyl group is preferable among them.

In Formula (1), x represents an integer of 0 or greater, y and z each represent an integer of 1 or greater, and (x+y+z) is from 10 to 200. x is preferably 5 or less from the viewpoint of exhibiting superior adhesive property. (x+y+z) is preferably from 40 to 60 since the organo-modified silicone is industrially easily available and superior in suppression of deterioration in adhesive property and flexibility.

Incidentally, the adhesive property tends to deteriorate when y and z are 0. In addition, the adhesive property tends to deteriorate and the suppression of deterioration in flexibility tends to be insufficient when (x+y+z) is less than 10. It tends to be difficult to handle and manufacture the organo-modified silicone when (x+y+z) exceeds 200.

From the viewpoint of exhibiting superior adhesive property, the molar ratio of the group represented by R² to the group represented by R³ in the organo-modified silicone represented by General Formula (1) above is preferably from 10:90 to 60:40 and more preferably from 25:75 to 50:50.

Incidentally, General Formula (1) does not mean a block copolymer structure, but the respective structural units may be arranged randomly, blockwisely, or alternately.

The organo-modified silicone represented by General Formula (1) above can be synthesized by any conventionally known method. Examples thereof may include a method in which a substituent is introduced into a raw material silicone having a SiH group by a hydrosilylation reaction and a method in which a cyclic organosiloxane is subjected to ring-opening polymerization. Among them, a method in which a substituent is introduced into a raw material silicone having a SiH group by a hydrosilylation reaction is preferable since it is an industrially easier method. This method will be described below.

The hydrosilylation reaction is a reaction in which an unsaturated compound which has a vinyl group and becomes R² or R³, is reacted with the raw material silicone having a SiH group stepwise or at once in the presence of a catalyst if necessary.

Examples of the raw material silicone may include methylhydrogensilicone having a polymerization degree of from 10 to 200 and a dimethylsiloxane-methylhydrogensiloxane copolymer. Among these, it is preferable to use methylhydrogensilicone having a polymerization degree of from 40 to 60 from the viewpoint of being industrially easily available.

Examples of the unsaturated compound having a vinyl group may include the following ones.

Examples of the unsaturated compound to be R² may include vinyl glycidyl ether, allyl glycidyl ether, and vinylcyclohexene oxide.

Examples of the unsaturated compound to be a hydrocarbon group having an aromatic ring and from 8 to 40 carbon atoms as R³ may include styrene, α-methylstyrene, vinylnaphthalene, allyl phenyl ether, allyl naphthyl ether, allyl-p-cumyl phenyl ether, allyl-o-phenyl phenyl ether, allyl-tri(phenylethyl) phenyl ether, and allyl-tri(2-phenylpropyl) phenyl ether.

Examples of the unsaturated compound to be an alkyl group having from 3 to 22 carbon atoms as R³ may include an a-olefin having from 3 to 22 carbon atoms, and specific examples thereof may include . propene, 1-butene, 1-pentene, 1-hexene, 1-heptene, 1-octene, 1-nonene, 1-decene, 1-undecene, and 1-dodecene.

The amounts of the raw material silicone and the unsaturated compound which are used in the reaction can be appropriately selected depending on the SiH group equivalent and number average molecular weight of the raw material silicone, and the like. The SiH group equivalent of the raw material silicone can be determined, for example, by the amount of hydrogen generated by the reaction of the raw material silicone with an aqueous solution of sodium hydroxide and an alcohol. The number average molecular weight can be determined, for example, by the number average molecular weight of an alkyl-modified silicone to be obtained by introducing an α-olefin into the raw material silicone by a hydrosilylation reaction. The number average molecular weight of the alkyl-modified silicone can be determined, for example, by a polyethylene glycol conversion method using GPC.

The reaction temperature and temperature for the hydrosilylation reaction are not particularly limited and can be appropriately adjusted. The reaction temperature is, for example, from 10° C. to 200° C. and preferably from 50° C. to 150° C. The reaction time is, for example, from 6 to 12 hours when the reaction temperature is from 50° C. to 150° C. A solvent may be used although the reaction proceeds even in the absence of a solvent. As the solvent, for example, dioxane, methyl isobutyl ketone, toluene, xylene, butyl acetate, and the like are used.

The organo-modified silicone (A) described above may be used singly or in combination of two or more kinds thereof.

Next, the epoxy compound (B) having an aromatic ring to be used in the sizing agent for synthetic fiber of the present embodiment will be described. Here, examples of the aromatic ring may include an aromatic ring hydrocarbon (including an aromatic ring hydrocarbon constituting a polycyclic aromatic ring as well) such as a benzene ring, a naphthalene ring, or an anthracene ring and a heteroaromatic ring such as furan, thiophene, pyrrole, or imidazole containing a heteroatom such as nitrogen or oxygen. As the aromatic ring, a benzene ring is preferable from the viewpoint of exhibiting superior adhesive property and bundling property.

As the epoxy compound (B) having an aromatic ring, those having two or more epoxy groups are preferable from the viewpoint of exhibiting superior adhesive property.

Specific examples of the epoxy compound (B) having an aromatic ring may include a glycidyl ether type epoxy compound, a glycidyl amine type epoxy compound, and a glycidyl ester type epoxy compound.

Examples of the glycidyl ether type epoxy compound may include a compound obtained by reacting a polyol having an aromatic ring with epichlorohydrin.

Examples of the polyol having an aromatic ring may include bisphenol A, bisphenol F, bisphenol AD, bisphenol S, those in which the benzene ring of these is substituted with a halogen group, a bisphenol type polyol such as an alkylene oxide adduct of these, a phenol novolac obtained by reacting phenol or cresol with formaldehyde in the presence of an acidic catalyst, a phenolic resole obtained by reacting phenol or cresol with formaldehyde in the presence of an alkaline catalyst, hydroquinone, resorcinol, 4,4′-dihydroxy-3,3′,5,5′-tetramethylbiphenyl, 1,6-dihydroxynaphthalene, 9,9-bis(4-hydroxyphenyl)fluorene, tris(p-hydroxyphenyl)methane, and tetrakis(p-hydroxyphenyl)ethane.

Examples of the glycidyl ether type epoxy compound obtained by the reaction of a bisphenol type polyol with epichlorohydrin may include a bisphenol type epoxy compound represented by the following General Formula (7).

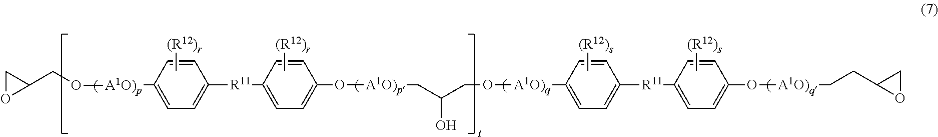

In Formula (7), R¹¹ represents a group represented by —CR¹³₂— or —SO₂—. R¹³s each independently represent a hydrogen atom, an alkyl group having from 1 to 3 carbon atoms, or a phenyl group, and a hydrogen atom or a methyl group is preferable from the viewpoint of exhibiting superior bundling property and adhesive property. R¹² represents an alkyl group having from 1 to 3 carbon atoms, a phenyl group, or a halogeno group. r and s each independently represent an integer from 0 to 2, and 0 is preferable from the viewpoint of exhibiting superior bundling property and adhesive, property. A¹Os each independently represent an alkyleneoxy group having 2 or 3 carbon atoms. p, p′, q, and q′ are an integer, (p+p′) and (q+q′) are each from 0 to 20. (p+p′) and (q+q′) are each preferably from 0 to 10 and more preferably from 0 to 4 from the viewpoint of exhibiting superior bundling property and adhesive property. t represents an integer from 0 to 10, and t is preferably from 0 to 5 and more preferably from 0 to 2 from the viewpoint of exhibiting superior bundling property and adhesive property.

As the phenol novolak type epoxy compound or phenolic resole type epoxy compound obtained by reacting the phenol novolac or phenolic resole with epichlorohydrin, those having an epoxy equivalent of from 150 to 270 are preferable and those having an epoxy equivalent of from 160 to 230 are more preferable from the viewpoint of exhibiting superior bundling property and adhesive property.

As the glycidyl ether type epoxy compound, a bisphenol type epoxy compound represented by General Formula (7) above and a phenol novolak type epoxy compound are preferable from the viewpoint of exhibiting superior adhesive property and bundling property.

Examples of the glycidyl amine type epoxy compound may include a compound obtained by reacting an amine having an aromatic ring and a plurality of active hydrogen with epichlorohydrin.

Examples of the amine having an aromatic ring and a plurality of active hydrogen may include a compound represented by the following General Formula (8), a diaminodiphenylalkane such as diaminodiphenylmethane, diaminodiphenylethane, or diaminodiphenylpropane, and 9,9-bis(4-aminophenyl)fluorene.

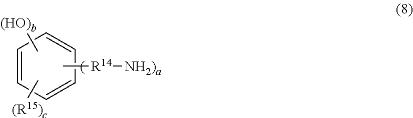

In Formula (8), R¹⁴ represents a single bond or an alkylene group having from 1 to 3 carbon atoms, and a single bond or a methylene group is preferable from the viewpoint of exhibiting superior adhesive property and bundling property. a represents an integer from 1 to 3. a is preferably 1 or 2 from the viewpoint of exhibiting superior adhesive property and bundling property. b represents an integer of 0 or 1. (a+b) is preferably 2 or more from the viewpoint of exhibiting superior adhesive property. Incidentally, in a case in which b is 1, epichlorohydrin reacts with both the hydroxyl group and amino group in the compound represented by General Formula (8) above in the reaction of the compound represented by General Formula (8) above with epichlorohydrin. R¹⁵ represents an alkyl group having from 1 to 3 carbon atoms, and c represents an integer from 0 to 2. R¹⁵ is preferably a methyl group and c is preferably 0 or 1 from the viewpoint of being more easily available.

Examples of the compound represented by General Formula (8) above may include aniline, toluidine, m-xylylenediamine, m-phenylenediamine, and an aminophenol. Examples of the aminophenol may include m-aminophenol, p-aminophenol, and 4-amino-3-methylphenol.

In addition, the hydrogen atom of the phenyl group and/or alkylene group in the diaminodiphenylalkane may be substituted with an alkyl group having from 1 to 3 carbon atoms. The alkylene group in the diaminodiphenylalkane preferably has 1 or 2 carbon atoms from the viewpoint of exhibiting superior adhesive property and bundling property. Examples of such a diaminodiphenylalkane may include 4,4′-diaminodiphenylmethane and 4,4′-diaminodiphenylethane.

As the amine having a plurality of active hydrogen, a compound represented by General Formula (8) above and the diaminodiphenylalkane are preferable from the viewpoint of exhibiting superior adhesive property and bundling property.

As the glycidyl amine type epoxy compound, a compound obtained by reacting the aminophenol with epichlorohydrin is preferable from the viewpoint of exhibiting superior adhesive property.

Examples of the glycidyl ester type epoxy compound may include a compound obtained by reacting a polycarboxylic acid having an aromatic ring such as a dicarboxylic acid having an aromatic ring such as phthalic acid, terephthalic acid, or hexahydrophthalic acid with epichlorohydrin.

The epoxy compound (B) described above may be, used singly or in combination of two or more kinds thereof.

As the epoxy compound (B) having an aromatic ring, at least one kind of epoxy compound selected from the group consisting of a glycidyl ether type epoxy compound, a glycidyl amine type epoxy compound, and a glycidyl ester type epoxy compound is preferable from the viewpoint of exhibiting superior adhesive property bundling property.

In addition, as the epoxy compound (B) having an aromatic ring, a glycidyl ether type epoxy compound and a glycidyl amine type epoxy compound are more preferable from the viewpoint exhibiting superior adhesive property and bundling property.

In the sizing agent for synthetic fiber of the present embodiment, the mass ratio (A):(B) of the organo-modified silicone (A) represented by General Formula (1) above to the epoxy compound (B) having an aromatic ring is preferably from 95:5 to 20:80, more preferably from 90:10 to 30:70, and still more preferably from 90:10 to 40:60 from the viewpoint of satisfying the maintenance of adhesive property, bundling property, and flexibility in a well-balanced manner at a higher level.

In the sizing agent for synthetic fiber of the present embodiment, the organo-modified silicone (A) represented by General Formula (1) above and the epoxy compound (B) having an aromatic ring may be used as a sizing agent as they are, or they can be prepared into a sizing agent by being dispersed and dissolved in an organic solvent, water, or a liquid mixture of an organic solvent and water. As the organic solvent, it is possible to use, for example, an alcohol such as methyl alcohol, ethyl alcohol, or isopropyl alcohol; a glycol or a glycol ether such as ethylene glycol, propylene glycol, ethylene glycol monoisopropyl ether, or ethylene glycol monobutyl ether; a ketone such as acetone or methyl ethyl ketone, and toluene.

The contents of the organo-modified silicone (A) represented by General Formula (1) above and the epoxy compound (B) having an aromatic ring in the sizing agent for synthetic fiber of the present embodiment can be appropriately adjusted depending on the stability and viscosity of the sizing agent, the organo-modified silicone (A) to be used, and the epoxy compound (B) to be used, but examples thereof may include an amount in which the total content of the component (A) and the component (B) is from 1% by mass to 100% by mass based on. the total amount of the sizing agent.

Examples of other components that can be added to the sizing agent for synthetic fiber of the present embodiment may include various kinds of surfactants, various kinds of smoothing agents, an antioxidant, a flame retardant, an antibacterial agent, and a defoaming agent. In addition, a polyurethane resin, a polyester resin, a polyamide resin, and the like may be added to the sizing agent for synthetic fiber in order to improve the friction resistance of the reinforcing fiber bundle and the impregnating property of the matrix resin. These additional components may be used singly or in combination of two or more kinds thereof.

It is possible to efficiently conduct the emulsification by using a surfactant as an emulsifier particularly in the case of using water as the solvent or dispersion medium of the sizing agent for synthetic fiber of the present embodiment. The surfactant is not particularly limited, and any known surfactant can be appropriately selected and used, and one kind of surfactant may be used or two or more kinds of surfactants may be concurrently used.

The method of manufacturing the sizing agent for synthetic fiber of the present embodiment is not particularly limited, and any known method can be adopted. For example, the sizing agent can be prepared by mixing and stirring an organic solvent, the organo modified silicone (A) represented by General Formula (1) above, the epoxy compound (B) having an aromatic ring, water, and a surfactant, and the sizing agent can also be prepared by further mixing and stirring the mixture thus prepared with water and other components if necessary.

By concurrently using the organo-modified silicone (A) represented by General Formula (1) above and the epoxy compound (B) having an aromatic ring, the sizing agent for synthetic fiber of the present embodiment not only functions as a so-called gluing agent which imparts excellent bundling property to a synthetic fiber bundle but can also impart excellent adhesive property with a matrix resin to the synthetic fiber bundle, and further, the sizing agent can sufficiently maintain the flexibility of the synthetic fiber bundle.

Next, the reinforcing fiber bundle according to the present invention will be described.

The reinforcing fiber bundle of the present embodiment is obtained by attaching the sizing agent for synthetic fiber of the present embodiment to a synthetic fiber bundle. The reinforcing fiber bundle of the present embodiment can be obtained by treating a synthetic fiber bundle to be used in a fiber-reinforced composite material with the sizing agent for synthetic fiber of the present embodiment, and the reinforcing fiber bundle is used to reinforce the matrix resin and to thus obtain a fiber-reinforced composite material.

The amount of the sizing agent attached to the synthetic fiber bundle can be appropriately selected, and for example, an amount in which the total attached amount of the attached amount (A) of the organo-modified silicone represented by General Formula (1) above and the epoxy compound (B) having an aromatic ring is from 0.05% by mass to 10% by mass based on the mass of the synthetic fiber bundle is preferable and an amount in which the total attached amount is from 0.1% by mass to 5% by mass is more preferable.

The adhesive property tends to be insufficient and the handling property deteriorates in some cases as the bundling property of the synthetic fiber bundle is insufficient when the attached amount of the sizing agent is an amount in which the total attached amount of the component (A) and the component (B) is less than 0.05% by mass with respect to the synthetic fiber bundle. On the other hand, it is difficult to obtain an effect corresponding to the attached amount and it tends to be disadvantageous in terms of cost when the total attached amount exceeds 10% by mass.

The method of attaching the sizing agent of the present embodiment to the synthetic fiber bundle is riot particularly limited, and the sizing agent can be attached to the synthetic fiber bundle by a kiss roller method, a roller dip method, a spray method, a dip method, and any known method. In addition, at the time of attachment, the sizing agent of the present embodiment may be attached to the synthetic fiber bundle as it is by the above method or the like, or a treatment liquid containing the sizing agent may be prepared and the treatment liquid may be then attached to the synthetic fiber bundle by the above method or the like.

Examples of the concentration of the treatment liquid may include a concentration at Which the total concentration of the organo-modified silicone (A) represented by General Formula (I) above and the epoxy compound (B) having an aromatic ring is from 0.5% by mass to 60% by mass. In addition, examples of the solvent to be used in the treatment liquid may include the organic solvents described above and water.

The drying method after the sizing agent is attached to the synthetic fiber bundle is not particularly limited, and examples thereof may include a method in which the sizing agent attached to the synthetic fiber bundle is dried by being heated at a temperature of from 90° C. to 300° C. for from 10 seconds to 10 minutes and more suitably at a temperature of from 100° C. to 250° C. for from 30 seconds to 4 minutes by using a heating roller, hot air, a hot plate, and the like.

In addition, a thermosetting resin such as a vinyl ester resin or a thermoplastic resin such as an urethane resin, a polyester resin, a nylon resin, or an acrylic resin may be attached to the synthetic fiber bundle in a range in which the effect of the present invention is not impaired.

The kind of the synthetic fiber bundle to which the sizing agent for synthetic fiber of the present embodiment can be applied is not particularly limited as long as it is a synthetic fiber to be used in a fiber-reinforced composite material. Examples thereof may include various kinds of inorganic fibers such as a carbon fiber, a glass fiber, and a ceramic fiber and various kinds of organic fibers such as an aramid fiber, a polyethylene fiber, a polyethylene terephthalate fiber, a polybutylene terephthalate fiber, a polyethylene naphthalate fiber, a polyarylate fiber, a polyacetal fiber, a PBO fiber, a polyphenylene sulfide fiber, and a polyketone fiber.

Among the above fibers, a carbon fiber is preferable from the viewpoint of exhibiting more favorable affinity for the organo-modified silicone (A) represented by General Formula (1) above and the epoxy compound (B) having an aromatic ring and further improving the adhesive property with the matrix resin. The form of the carbon fiber is not particularly limited, and examples thereof may include a form in which from thousands to tens of thousands of known carbon fiber filaments such as polyacrylonitrile-based (PAN) carbon fiber filaments, rayon-based carbon fiber filaments, or pitch-based carbon fiber filaments are bundled. In the present embodiment, it is preferable to attach the sizing agent for synthetic fiber of the present embodiment to a bundle of carbon fibers which are sufficiently carbonized through a heating carbonization treatment. As such a carbon fiber, one of which 90% or more is composed of carbon in a mass ratio is still more preferable.

Examples of the form of use of the reinforcing fiber bundle of the present embodiment may include forms such as a bundle, a woven fabric, a knitted fabric, a braided cord, a web, a mat, and a chopped form, and the form of use can be appropriately selected according to the purpose and the method of use.

According to the reinforcing fiber bundle of the present embodiment, it is possible to obtain sufficient adhesive property as the affinity of the reinforcing fiber bundle for the matrix resin is favorable and to obtain a fiber-reinforced composite material having an excellent strength since the reinforcing fiber bundle is treated with the sizing agent of the present embodiment. In addition, the reinforcing fiber bundle of the present embodiment exhibits excellent winding property onto the roll and handling property since the flexibility of the synthetic fiber can be sufficiently maintained in the reinforcing fiber bundle.

Next, the fiber-reinforced composite material according to the present invention will be described.

The fiber-reinforced composite material of the present embodiment contains a matrix resin and the reinforcing fiber bundle of the present embodiment described above.

As the reinforcing fiber bundle of the fiber-reinforced composite material of the present embodiment, one in which the synthetic fiber is a carbon fiber is preferable.

As the matrix resin, both of a thermosetting resin and a thermoplastic resin can be used.

The thermosetting resin is not particularly limited, and any resin can be used as long as it is a resin which undergoes the crosslinking reaction by heat and thus at least partly forms a three-dimensional crosslinked structure. Examples thereof may include an epoxy resin, an unsaturated polyester resin, a vinyl ester resin, a phenol resin, a melamine resin, a urea resin, a cyanate ester resin, and a bismaleimide resin. These thermosetting resins may be those that self-cure by being heated or those that are blended with a curing agent, a curing accelerator, or the like.

Examples of the thermoplastic resin may include a polyolefin-based resin, a polyamide-based resin, a polycarbonate-based resin, and a polyphenylene sulfide-based resin.

Among the above resins, a thermosetting resin is preferable, and among them, an epoxy resin is preferable from the viewpoint of exhibiting more favorable affinity for the organo-modified silicone (A) represented by General Formula (1) above and the epoxy compound (B) having an aromatic ring and further improving the adhesive property with the matrix resin. As the epoxy resin, it is possible to use any of a glycidyl ether type, a glycidyl ester type, a glycidyl amine type, or an alicyclic type. Specifically, a bisphenol A type, a bisphenol F type, a bisphenol S type, a biphenyl type, a naphthalene type, a fluorene type, a phenol novolac type, an aminophenol, and an aniline type are used.

The method of manufacturing the fiber-reinforced composite material of the present embodiment is not particularly limited, and any conventionally known method can be adopted.

Examples thereof may include a method in which the fiber reinforcing bundle of the present embodiment is impregnated with a matrix resin and the matrix resin is then cured by being heated and a method in which a prepreg obtained by impregnating the reinforcing fiber bundle of the present embodiment with a matrix resin is fabricated and the prepreg is laminated, and the matrix resin is then cured by being heated while applying a pressure to the laminate in a case in which the matrix resin is a thermosetting resin.

In addition, a curing agent and a curing accelerator may be added to the thermosetting resin if necessary. For example, for curing of the epoxy resin, a Lewis acid such as a boron halide complex or a p-toluenesulfonate salt, polyamine curing agents such as diaminodiphenyl sulfone, diaminodiphenyl methane, and derivatives and isomers thereof, and the like are preferably used.

In addition, the prepreg described above is also included in one aspect of the fiber-reinforced composite material of the present embodiment, but examples of the fabricating method thereof may include a wet method in which the matrix resin is dissolved in a solvent such as methyl ethyl ketone or methanol to lower the viscosity and then impregnated into the reinforcing fiber bundle of the present embodiment and a hot melt method (dry method) in which the matrix resin is heated to lower the viscosity and then impregnated into the reinforcing fiber bundle of the present embodiment.

Examples of the method of manufacturing the fiber-reinforced composite material may include molding methods such as injection molding, blow molding, rotational molding, extrusion molding, press molding, transfer molding, and filament winding molding in a case in which the matrix resin is a thermoplastic resin. Among these, injection molding is preferably used from the viewpoint of productivity. In addition, in these molding methods, there is also a case in which a form such as a pellet obtained by kneading a thermally melted thermoplastic resin and a reinforcing fiber bundle or a prepreg obtained by impregnating a reinforcing fiber bundle with a thermally melted thermoplastic resin is first obtained and the form is used in a desired molding, but these pellets and prepregs are also included in one aspect of the fiber-reinforced composite material of the present embodiment.

### EXAMPLES

Hereinafter, the present invention will be described in more detail with reference to Examples, but the present invention is not limited by these Examples at all.

[Manufacture of Sizing Agent and Reinforcing Fiber Bundle]

<Manufacture of Organo-Modified Silicone (A)>

### Preparation Example 1

As raw material silicone, methyl hydrogen silicone represented by the following formula (in the formula, 50 represents the average polymerization degree) was prepared.

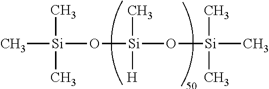

The raw material silicone (63 g) was put in a reaction vessel equipped with a stirrer, a thermometer, a reflux condenser, a nitrogen gas introducing tube, and a dropping funnel, nitrogen was allowed to flow thereinto, and the mixture was mixed until to be uniform while heating until the temperature thereof reached 65° C. As a hydrosilylation catalyst, a mixed solution of ethylene glycol monobutyl ether and toluene of platinum (IV) chloride was added to the reaction system such that the platinum concentration was 5 ppm with respect to the reactant. When the temperature of the reactant reached 120° C., 0.5 mol of α-methylstyrene (59.1 g) was added thereto dropwise, and the mixture was reacted at 120° C. for 1 hour.

Thereafter, 0.5 mol of allyl glycidyl ether (57.1 g) was added thereto dropwise, and the mixture was reacted at 120° C. for 3 hours, thereby completing the addition reaction. The confirmation of completion of the addition reaction was carried out by confirming that the absorption spectrum derived from the SiH group in the raw material silicone had disappeared through FT-IR analysis of the organo-modified silicone thus obtained.

<Manufacture of Sizing Agent>

### Example 1

The organo-modified silicone obtained in Preparation Example 1, a bisphenol type epoxy compound (B)-1 represented by the following formula (a mixture of compounds in which n is 0 or 1, average molecular weight: 370) as an epoxy compound (B) having an aromatic ring, and polyoxyethylene alkyl ether (product name: SOFTANOL 90 manufactured by NIPPON SHOKUBAI CO., LTD) as an emulsifier were mixed with water such that the concentrations thereof were 5% by mass, 5% by mass, and 1% by mass, respectively, thereby obtaining a sizing agent.

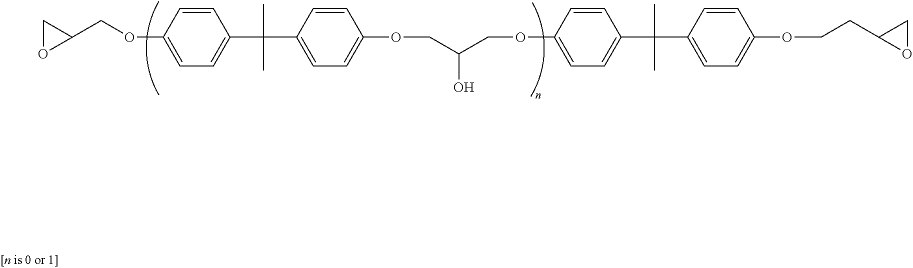

### Example 2

A sizing agent was Obtained in the same manner as in Example 1 except that the epoxy compound (B) having an aromatic ring was changed to a bisphenol type epoxy compound (B)-2 represented by the following formula (a mixture of compounds in which n is 0, 1, or 2, average molecular weight: 900).

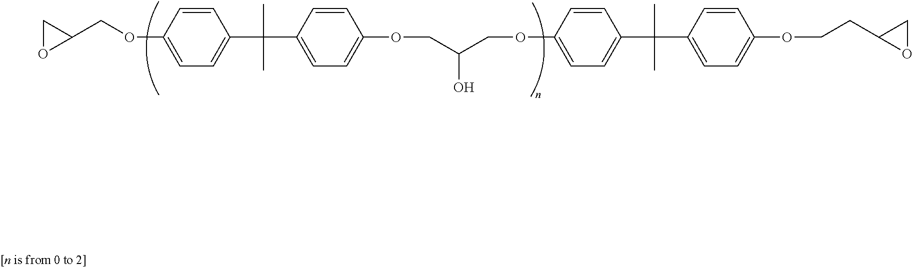

### Example 3

A sizing agent was obtained in the same manner as in Example 1 except that the epoxy compound (B) having an aromatic ring was changed to a bisphenol type epoxy compound (B)-3 represented by the following formula (product name: RIKARESIN BPO-20E manufactured by New Japan Chemical Co., Ltd.).

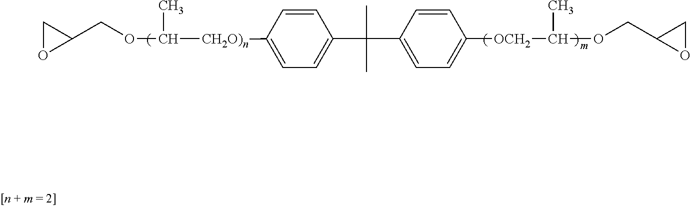

### Example 4

A sizing agent was obtained in the same manner as in Example 1 except that the epoxy compound (B) having an aromatic ring was changed to a glycidyl amine type epoxy compound (B)-4 represented by the following formula.

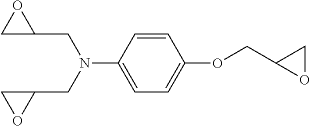 [SMILES: c1cc(N(CC2CO2)CC2CO2)ccc1OCC1CO1]

### Example 5

A sizing agent was obtained in the same manner as in Example 1 except that the epoxy compound (B) having an aromatic ring was changed to a phenol novolak type epoxy compound (B)-5 (product name: Epotohto YDPN-638 manufactured by NIPPON STEEL & SUMIKIN CHEMICAL CO., LID., epoxy equivalent: 170 to 190).

### Examples 6 to 11

Sizing agents were respectively obtained in the same manner as in Example 1 except that the compositions of the sizing agents were changed to the compositions presented in Table 1 or 2.

### Example 12

A sizing agent was obtained in the same manner as in Example 1 except that acetone was used instead of the emulsifier and water.

### Comparative Examples 1 to 4

Sizing agents were respectively obtained in the same manner as in Example 1 except that the compositions of the sizing agents were changed to the compositions presented in Table 3.

<Manufacture of Reinforcing Fiber Bundle>

As a synthetic fiber bundle, one obtained by washing commercially available carbon fibers (product name: TR50S15L manufactured by Mitsubishi Rayon Co., Ltd., fiber tensile strength: 4900 MPa) with acetone to remove the attached sizing agent was prepared as a carbon fiber bundle.

### Example 13

The carbon fiber bundle was dip treated with the sizing agent obtained in Example 1, squeezed, and then dried by hot air at 100° C. for 3 minutes, thereby obtaining a reinforcing carbon fiber bundle having an attached amount of the sizing agent of 2% by mass based on the mass of the carbon fiber bundle in terms of the total attached amount (not containing the emulsifier) of the organo-modified silicone and the epoxy compound (B).

### Examples 14 to 24

Reinforcing carbon fiber bundles were obtained in the same manner as in Example 13 except that the sizing agent was changed to those presented in Table 4 or 5.

### Comparative Examples 5 to 8

Reinforcing carbon fiber bundles were obtained in the same manner as in Example 13 except that the sizing agent was changed to those presented in Table 6.

[Evaluation of Performance]

The bundling property, adhesive property, and flexibility of the reinforcing carbon fiber bundles obtained above were evaluated by the following methods. The results are presented in Tables 4 to 6.

<Bundling Property>

First, the upper end of a reinforcing fiber bundle having a length of 50 cm was fixed and the lower end thereof was hung with a load of 50 g. Subsequently, the reinforcing fiber bundle was cut with sharp scissors at the place distant about 20 cm from the lower end, and the maximum diameter of the cross section of the reinforcing fiber bundle left was measured. It indicates that the bundling property is more favorable as the maximum diameter is smaller.

<Adhesive Property>

The adhesive property between the reinforcing fiber bundle and the matrix resin was evaluated by using the interfacial shear strength that was an index of adhesive property. It indicates that the adhesive property is superior as the interfacial shear strength is higher. Incidentally, the interfacial shear strength was measured by a single fiber embedding (fragmentation) method. Specifically, the measurement was conducted according to the following procedure.

First, one single fiber was drawn out from the reinforcing fiber bundle thus obtained and embedded in a matrix resin to prepare a test piece. A tension greater than the rupture elongation of the fiber was applied to this test piece (implementation of tensile testing). The number of ruptures on the single fiber ruptured in the matrix resin was read by using a polarization microscope, the average value (average fiber length) of the respective ruptured fiber lengths was determined from the number of ruptures and the single fiber length, and the interfacial shear strength was calculated by the following equation.

Critical fiber length (mm)=4×average fiber length (mm)/3

Interfacial shear strength (MPa)=fiber tensile strength (MPa)×(fiber diameter (mm)/2)×critical fiber length (mm)

Incidentally, the fiber tensile strength is an intrinsic physical property value of fiber, and the fiber tensile strength of the carbon fiber bundle used in Examples is 4900 MPa as described above. In addition, the matrix resin used in the fabrication of the test piece is one obtained by mixing a bisphenol A type epoxy resin (product name: jER 828 manufactured by Mitsubishi Chemical Holdings Corporation), dicyandiamide as a curing agent, and 3-(3,4-dichlorophenyl)-1,1-dimethylurea as a curing accelerator at proportions of 100 parts by mass, 8 parts by mass, and 4 parts by mass, pouring this mixture into a mold in which one single fiber was fixed, and curing this mixture at a temperature of 120° C. for 1 hour. The tensile test was conducted at a temperature of 20° C. and a humidity of 65%, and a tension was applied to the test piece in a range in which the test piece did not rupture (elongation: 5%).

<Flexibility>

The resistance force (gf, 1 [gf]=9.81 [gm/s²]) when the reinforcing fiber bundle was pressed from above was measured by using the Handle-o-Meter (manufactured by KUMAGAI REM KOGYO Co., Ltd.) to be used for the E method (handle-a-meter method) of JIS L 1096 (2010), and the flexibility was evaluated. Incidentally, the measurement was conducted three times by setting the slot width to 20 mm and applying a load to the center of the reinforcing fiber bundle having a length of 30 cm. The average value (unit is gm/s²) thereof is presented in the tables. It indicates that the reinforcing fiber bundle is more flexible as the numerical value is smaller.

TABLE 1

| | | | Example 1 | Example 2 | Example 3 | Example 4 | Example 5 | Example 6 |
|---|---|---|---|---|---|---|---|---|
| Composition | Organo-modified | Adjustment | 5 | 5 | 5 | 5 | 5 | 9.5 |
| of sizing | silicone (A) | Example 1 | | | | | | |
| agent | Epoxy | (B)-1 | 5 | | | | | 0.5 |
| (parts by | compound (B) | (B)-2 | | 5 | | | | |
| mass) | having an | (B)-3 | | | 5 | | | |
| | aromatic ring | (B)-4 | | | | 5 | | |
| | | (B)-5 | | | | | 5 | |

| Emulsifier | 1 | 1 | 1 | 1 | 1 | 1 |
|---|---|---|---|---|---|---|
| Water | Remainder | Remainder | Remainder | Remainder | Remainder | Remainder |
| Acetone | | | | | | |
| Total amount | 100 | 100 | 100 | 100 | 100 | 100 |
| Mass ratio of (A) to (B) | 50:50 | 50:50 | 50:50 | 50:50 | 50:50 | 95:5 |

TABLE 2

| | | | | | | Example | Example | Example |
|---|---|---|---|---|---|---|---|---|
| | | | Example 7 | Example 8 | Example 9 | 10 | 11 | 12 |
| Composition | Organo-modified | Adjustment | 7 | 3 | 2 | 5 | 5 | 5 |
| of sizing agent | silicone (A) | Example 1 | | | | | | |
| (parts by | Epoxy compound | (B)-1 | 3 | 7 | 8 | 2.5 | 2.5 | 5 |
| mass) | (B) having an | (B)-2 | | | | 2.5 | | |
| | aromatic ring | (B)-3 | | | | | | |
| | | (B)-4 | | | | | | |
| | | (B)-5 | | | | | 2.5 | |

| Emulsifier | 1 | 1 | 1 | 1 | 1 | |
|---|---|---|---|---|---|---|
| Water | Remainder | Remainder | Remainder | Remainder | Remainder | |
| Acetone | | | | | | Remainder |
| Total amount | 100 | 100 | 100 | 100 | 100 | 100 |
| Mass ratio of (A) to (B) | 70:30 | 30:70 | 20:80 | 50:50 | 50:50 | 50:50 |

TABLE 3

| | | | Comparative | Comparative | Comparative | Comparative |
|---|---|---|---|---|---|---|
| | | | Example 1 | Example 2 | Example 3 | Example 4 |
| Composition | Organo-modified | Adjustment | 10 | | 5 | |
| of sizing agent | silicone (A) | Example 1 | | | | |
| (parts by | Epoxy compound | (B)-1 | | 10 | | 5 |
| mass) | (B) having an | | | | | |
| | aromatic ring | | | | | |

| 1,6-Hexanediol diglycidyl ether | | | 5 | 5 |
|---|---|---|---|---|
| Emulsifier | 1 | 1 | 1 | 1 |
| Water | Remainder | Remainder | Remainder | Remainder |
| Total amount | 100 | 100 | 100 | 100 |
| Mass ratio of (A) to (B) | — | — | — | — |

TABLE 4

| | | Example | Example | Example | Example | Example | Example |
|---|---|---|---|---|---|---|---|
| | | 13 | 14 | 15 | 16 | 17 | 18 |
| Sizing agent | | Example 1 | Example 2 | Example 3 | Example 4 | Example 5 | Example 6 |
| Synthetic fiber bundle | | Carbon | Carbon | Carbon | Carbon | Carbon | Carbon |
| | | fiber | fiber | fiber | fiber | fiber | fiber |
| | | bundle | bundle | bundle | bundle | bundle | bundle |
| Evaluation of | Bundling property (mm) | 7 | 7 | 7 | 8 | 7 | 9 |
| performance | Interfacial shear strength (MPa) | 28 | 29 | 29 | 31 | 30 | 29 |
| | Flexibility | 54.8 | 60.2 | 52.6 | 55.1 | 63.4 | 52.9 |

TABLE 5

| | | Example | Example | Example | Example | Example | Example |
|---|---|---|---|---|---|---|---|
| | | 19 | 20 | 21 | 22 | 23 | 24 |
| Sizing agent | | Example 1 | Example 2 | Example 3 | Example 4 | Example 5 | Example 6 |
| Synthetic fiber bundle | | Carbon | Carbon | Carbon | Carbon | Carbon | Carbon |
| | | fiber | fiber | fiber | fiber | fiber | fiber |
| | | bundle | bundle | bundle | bundle | bundle | bundle |
| Evaluation of | Bundling property (mm) | 8 | 7 | 7 | 7 | 7 | 7 |
| performance | Interfacial shear strength (MPa) | 29 | 27 | 26 | 27 | 29 | 28 |
| | Flexibility | 53.8 | 55.3 | 55.1 | 56.8 | 57.2 | 54.7 |

TABLE 6

| | | Comparative | Comparative | Comparative | Comparative |
|---|---|---|---|---|---|
| | | Example 5 | Example 6 | Example 7 | Example 8 |
| Sizing agent | | Comparative | Comparative | Comparative | Comparative |
| | | Example 1 | Example 2 | Example 3 | Example 4 |
| Synthetic fiber bundle | | Carbon fiber | Carbon fiber | Carbon fiber | Carbon fiber |
| | | bundle | bundle | bundle | bundle |
| Evaluation of | Bundling property (mm) | 11 | 7 | 8 | 7 |
| performance | Interfacial shear strength (MPa) | 23 | 14 | 18 | 13 |
| | Flexibility | 52 | 55.8 | 54.9 | 55.9 |

As can be seen from the results of Tables 4 and 5, the sizing agent of the present invention can simultaneously achieve sufficient maintenance of flexibility of the reinforcing carbon fiber bundle and impartment of excellent adhesive property with the matrix resin to the reinforcing carbon fiber bundle.

### INDUSTRIAL APPLICABILITY

By using the sizing agent and reinforcing fiber bundle of the present invention, it is possible to obtain a fiber-reinforced composite material exhibiting excellent adhesive property between the matrix resin and the reinforcing fiber bundle. In addition, the reinforcing fiber bundle of the present invention obtained by using the sizing agent of the present invention exhibits favorable handling property, and the working property can be thus improved.

The fiber-reinforced composite material thus obtained is useful in various kinds of parts and members such as automobile parts, internal members, and housings.

1. A sizing agent for synthetic fiber comprising:
an organo-modified silicone (A) represented by the following General Formula (1); and
an epoxy compound (B) having an aromatic ring, 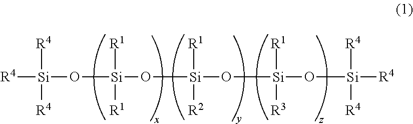
[in Formula (1), R¹ represents a hydrogen atom, a methyl group, or an ethyl group, R² represents a group represented by the following Formula (2), R³ represents a hydrocarbon group having an aromatic ring and from 8 to 40 carbon atoms or an alkyl group having from 3 to 22 carbon atoms, R⁴ represents the same group as R¹, R², or R³, and a plurality of R¹s, R²s, R³s, or R⁴s may be the same as or different from one another when there are a plurality of R²s, R²s, R³s, or R⁴s, x represents an integer of 0 or greater, y and z each represent an integer of 1 or greater, and (x+y+z) is from 10 to 200. 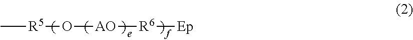
{in Formula (2), R⁵ represents an alkylene group having from 2 to 6 carbon atoms, AO represents an alkyleneoxy group having from 2 to 4 carbon atoms, R⁶ represents an alkylene group having from 1 to 6 carbon atoms, e represents an integer from 0 to 4, f represents an integer of 0 or 1, and Ep represents a group represented by the following Formula (3) or the following Formula (4).

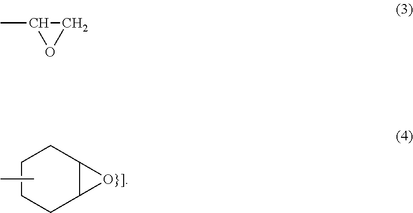

2. The sizing agent for synthetic fiber according to claim 1, wherein the epoxy compound (B) is at least one kind of epoxy compound selected from the group consisting of a glycidyl ether type epoxy compound, a glycidyl amine type epoxy compound, and a glycidyl ester type epoxy compound.

3. The sizing agent for synthetic fiber according to claim 1, wherein the epoxy compound (B) is at least one kind of epoxy compound selected from the group consisting of a compound obtained by reacting a polyol having an aromatic ring with epichlorohydrin, a compound obtained by reacting an amine having an aromatic ring and a plurality of active hydrogen with epichlorohydrin, a compound obtained by reacting a polycarboxylic acid having an aromatic ring with epichlorohydrin.

4. The sizing agent for synthetic fiber according to claim 1, wherein a mass ratio (A):(B) of the organo-modified silicone (A) to the epoxy compound (B) is from 95:5 to 20:80.

5. A reinforcing fiber bundle comprising the sizing agent for synthetic fiber according to claim 1, attached to a synthetic fiber bundle.

6. The reinforcing fiber bundle according to claim 5, wherein the synthetic fiber bundle is a carbon fiber bundle.

7. A fiber-reinforced composite material comprising a matrix resin and the reinforcing fiber bundle according to claim 5.

8. The sizing agent for synthetic fiber according to claim 2, wherein a mass ratio (A):(B) of the organo-modified silicone (A) to the epoxy compound (B) is from 95:5 to 20:80.

9. The sizing agent for synthetic fiber according to claim 3, wherein a mass ratio (A):(B) of the organo-modified silicone (A) to the epoxy compound (B) is from 95:5 to 20:80.

10. The reinforcing fiber bundle comprising the sizing agent for synthetic fiber according to claim 2 attached to a synthetic fiber bundle.

11. The reinforcing fiber bundle comprising the sizing agent for synthetic fiber according to claim 3 attached to a synthetic fiber bundle.

12. The reinforcing fiber bundle comprising the sizing agent for synthetic fiber according to claim 4 attached to a synthetic fiber bundle.

13. The reinforcing fiber bundle comprising the sizing agent for synthetic fiber according to claim 8 attached to a synthetic fiber bundle.

14. The reinforcing fiber bundle comprising the sizing agent for synthetic fiber according to claim 9 attached to a synthetic fiber bundle.

15. The fiber-reinforced composite material comprising a matrix resin and the reinforcing fiber bundle according to claim 6.

16. The fiber-reinforced composite material comprising a matrix resin and the reinforcing fiber bundle according to claim 10.

17. The fiber-reinforced composite material comprising a matrix resin and the reinforcing fiber bundle according to claim 11.

18. The fiber-reinforced composite material comprising a matrix resin and the reinforcing fiber bundle according to claim 12.

19. The fiber-reinforced composite material comprising a matrix resin and the reinforcing fiber bundle according to claim 13.

20. The fiber-reinforced composite material comprising a matrix resin and the reinforcing fiber bundle according to claim 14.
